(19) United States
(12) Patent Application Publication
(10) Pub. No.: US 2014/0019279 A1
(43) Pub. Date: Jan. 16, 2014

(54) System and Method for Requesting Assistance from a Store Attendant

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/549,219

(22) Filed: Jul. 13, 2012

(51) Int. Cl. G06Q 10/06; G06Q 30/00

(52) U.S. Cl. 705/26.1; 235/375

(57) ABSTRACT

An approach is provided for requesting assistance from a store attendant. One method includes receiving a request from a customer via mobile phone. The request may be received via scanning of the barcode located nearby to the customer. After scanning of the barcode, a notification is sent to the store attendants comprising aisle location to the store attendants. Subsequently, estimated time for assistance is received from the store attendants by the system. Thereafter, based on the received estimated time from the store attendants, a store attendant is selected from the store attendants. Finally, the system sends the estimated time for assistance to the mobile phone of the customer and the most appropriate store attendant is sent to the customer's location.

### BACKGROUND

The invention relates to an approach for requesting assistance from a store attendant. More specifically, the invention presents a unique system and method for requesting assistance by a customer in a store via a mobile device.

Shopping Venues and complexes have become a reality of the present. Presently, the majority of the world shops in places like Walmart, Target and large shopping malls, and such places have become an essential part of peoples' lives.

While shopping in these huge venues, there are many instances when a customer requires assistance from store attendants. For example, a customer may require some information about a product, or they may be trying to locate a product, or they may wish to inquire the price of a product with a missing price tag. Searching for a store attendant is a cumbersome task in such huge shopping venues and it may happen that a store attendant may not be available nearby. Also, it is possible that a store attendant is nearby, possibly as close as one aisle across. However, a customer may not search for the store attendant in the right direction, and thus is not able to easily locate the store attendant. This may result in a customer being unhappy and sometimes losing interest in buying the product because of the effort involved. This ultimately results in a loss in revenues and brand recognition for the shopping venue.

In light of the foregoing discussion, there exists a need for a new approach to help customers request assistance from store attendants. Further, it is desirable to be able to help a customer actually receive assistance in least possible time, and this results from an efficient work load distribution among store attendants. Moreover, a new approach should help in efficient employee utilization by gathering employee utilization stats. As will be seen, the invention provides such an approach in an elegant manner.

### BRIEF DESCRIPTION OF THE DRAWINGS

In order for the advantages of the invention to be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows an exemplary environment in which various embodiments of the invention can be practiced.

FIG. 2 shows the system according to an embodiment of the invention.

FIG. 3 shows the system according to another embodiment of the invention.

FIG. 4 shows a schematic flowchart for requesting assistance from a store attendant in accordance with an embodiment of the invention.

FIG. 5 shows a schematic flowchart for requesting assistance from a store attendant in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve an understanding of embodiments of the invention.

### DETAILED DESCRIPTION OF THE DRAWINGS

Before describing in detail any particular system or method for requesting assistance from a store attendant in accordance with embodiments of the invention, it should be observed that the invention resides primarily in combinations of system components related to the device of exemplary embodiments of the invention.

Accordingly, system and method components have been represented where appropriate by conventional symbols in the drawings, showing only those specific details that are pertinent to understanding the invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprise the element.

The invention illustrates a method and system for requesting assistance by a customer from a store attendant. The present system teaches receiving request from a customer via communication device of the customer such as mobile phone of the customer. The request may be received via scanning of the barcode located nearby to the customer.

In some embodiments, the request may be received by scanning a product barcode or a barcode on a shelf.

On scanning the barcode, a notification is sent to the store attendants comprising aisle location. Examples of the notification include, but are not limited to a “Push” notification or a “Poll” for new notifications. In response to the notification, estimated time for assistance is received from the store attendants by the system. Based on the received estimated times from store attendants, a store attendant is selected from the store attendants. Finally, the system sends the estimated time for assistance of the selected store attendant to the mobile phone of the customer and the selected store attendant is sent to the customer's location.

In certain embodiments, the system may contain an SPS (Store positioning system) module configured to track the location of the store attendants, and in other embodiments the customer may be integrated into the network with a mobile device such as a smartphone that is enabled with a GPS (Global Positioning system). Examples of the SPS module include, but are not limited to, one or multiple of GPS, SSID (Service Set Identifier) tracking triangulation, computer vision tracking, or any other means of positioning a human or mobile device inside a building. Subsequently, based on the location gathered by the SPS module, a notification can be sent to the selected nearby store attendants and a store attendant is selected from these selected store attendants for assisting the customer.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages. The program code may be executed entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (for example, through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The invention is described below with reference to flowchart illustrations and/or block diagrams of methods, apparatus or systems, and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

An object of the invention is to provide a system and method for requesting assistance by a customer from a store attendant.

Another object of the invention is to provide a system and method for providing assistance to the customer in least possible time by efficient work load distribution among the store attendants.

In accordance with one embodiment, a system for requesting assistance by a customer in a store may include a barcode, a notification module, a time module, a selection module and a feedback module. The customer requiring assistance can scan the barcode through a communication device, receiving the data required to identify the product. The notification module then may send a notification comprising aisle location to one or more store attendants. Further, the time module may receive estimated time for assistance from the one or more store attendants. The selection module can select a store attendant which may be one selected from the one or more store attendants based on estimated time received for assistance received from the one or more store attendants. The feedback module may then send the estimated time for assistance of the selected store attendant to the customer.

In accordance with yet another embodiment, a system for requesting assistance by a customer in a store may include a barcode, an SPS module, a tracking module, a notification module, a time module, a selection module, and a feedback module. The customer requiring assistance scans the barcode through a communication device. The SPS module gets the location of the one or more store attendants. The tracking module selects at least one store attendant based on the location of the one or more store attendants. The notification module sends a notification comprising aisle location to at least one store attendant. The time module receives estimated time for assistance from the at least one store attendant. The selection module selects a store attendant from at least one store attendant selected based on the estimated time for assistance received from the at least one store attendant. The feedback module sends the estimated time for assistance of the selected store attendant to the customer.

In accordance with yet another embodiment, a method for requesting assistance by a customer in a store may include receiving request from a customer through a communication device of the customer and sending a notification comprising aisle location to one or more store attendants. Subsequently, estimated time is received for assistance from the one or more attendants and a store attendant is selected from the one or more store attendants based on the estimated time for assistance received from the one or more store attendants. Finally, the method includes sending estimated time for assistance of the selected store attendant to the customer.

In accordance with still another embodiment, a method for requesting assistance by a customer in a store may include receiving request from a customer through a communication device of the customer and subsequently getting the location of one or more store attendants. Further, the method includes selecting at least one store attendant based on the location of the one or more store attendants and sending a notification comprising aisle location to the at least one store attendant. Further, the method may include receiving estimated time for assistance from the at least one store attendant and thereafter selecting a store attendant from the at least one store attendant, the store attendant being selected based on the estimated time for assistance received from the at least one store attendant, and finally sending the estimated time for assistance of the selected store attendant to the customer.

The invention has been developed in response to the present state of the art and, in particular, in response to the problems and needs in the art that have not yet been fully solved by currently available apparatus and methods. The device and method of the invention possesses a number of advantages. The system and method helps the customers in getting assistance from the store attendants. The system and method facilitates the customer in getting the assistance in least possible time resulting from efficient work load distribution among the store attendant. Moreover, the system and method help in efficient employee utilization by gathering employee utilization stats.

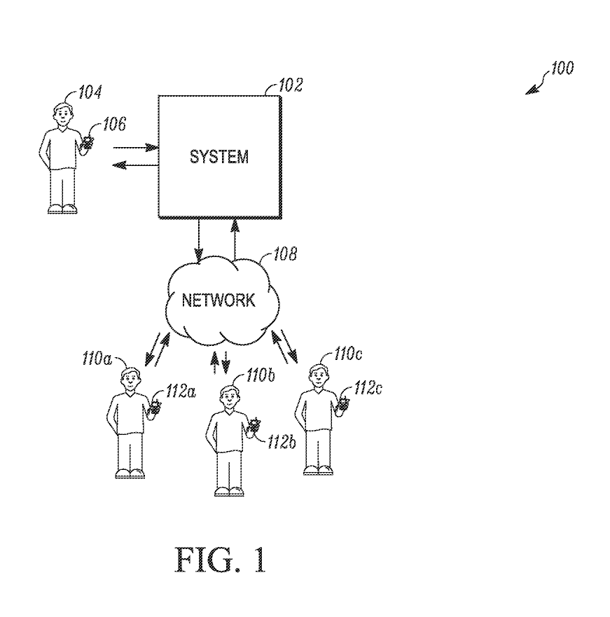

FIG. 1 shows an exemplary environment 100 in which various embodiments of the invention can be practiced. Environment 100 includes a system 102, a customer 104 having a communication device 106, a network 108 and one or more store attendants such as 110a, 110b and 110c, hereinafter collectively referred to as one or more store attendants 110 or store attendant 110. Store attendant 110 has one or more input devices such as 112a, 112b and 112c, hereinafter collectively referred to as input device 112. Customer 104 interacts with system 102 via communication device 106 for requesting assistance from a store attendant. Examples of communication device 106 include, but are not limited to, a PDA, a mobile phone, an iPad®, a tablet and a cellphone.

In certain embodiments, the interaction for requesting assistance may include scanning a product barcode or a barcode on a shelf.

In some other embodiments, the interaction for requesting assistance may include taking a photo of a shelf. Subsequently, the photo is shared with the attendants through the system 102 for recognition of the aisle and hence location of the customer 104.

Further, system 102 interacts with the one or more store attendants 110 through network 108. Examples of network 108 include, but are not limited to, Bluetooth, Infrared, internet, VPN (Virtual Private Network), mobile operator network and Wi-Fi. Network 108 includes not only a physical network but also a content network, which is comprised of the data—attributable to a single entity—which resides across all physical networks. Communication device 106, input device 112 other computing devices and other devices may be connected to network 108 via twisted pair wires, coaxial cable, fiber optics, radio waves or other media.

Moreover, store attendant 110 has input device 112 for communication with the system 102 via the network 108. Examples of input device 112 include, but are not limited to, a PDA, a mobile phone, an iPad®, a tablet and a cellphone.

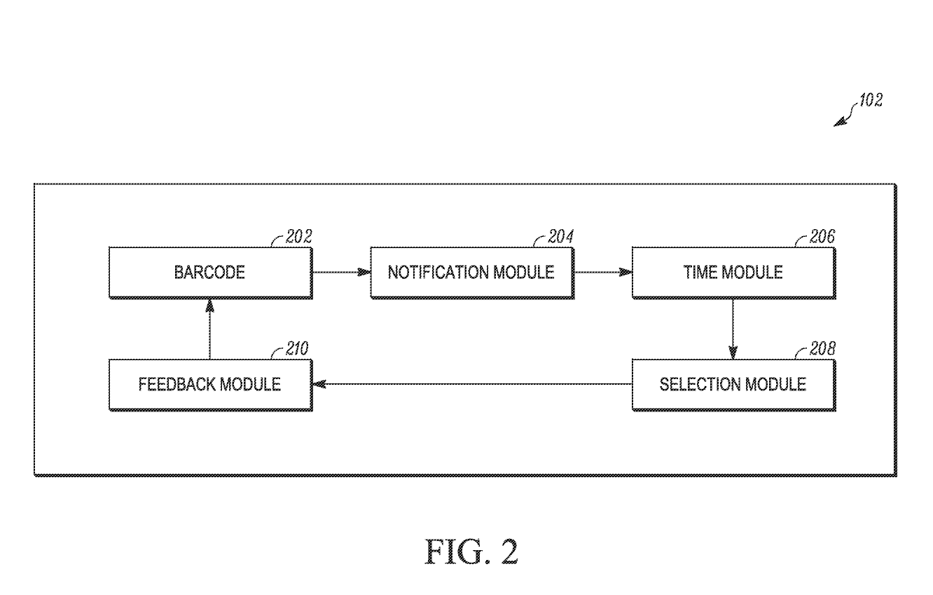

FIG. 2 shows system 102 according to an embodiment of the invention. System 102 for requesting assistance by a customer in a store includes a barcode 202, a notification module 204, a time module 206, a selection module 208 and a feedback module 210. Barcode 202 is scanned through a communication device by the customer requiring assistance.

According to an embodiment of the invention, customer 104 scans barcode 202 with an application on the mobile phone.

According to some embodiments, barcode module 202 functions corresponding to scanning a product barcode or a barcode on a shelf.

Subsequently, notification module 204 sends a notification comprising aisle location to one or more store attendants 110. Examples of the notification include, but are not limited to a “Push” notification or a “Poll” for new notifications.

According to an embodiment of the invention, each of the one or more store attendants 110 input the estimated time for assisting the customer 104 on receiving the notification, via input device 112. The estimated time input depends on one or more factors. Examples of the one or more factors include, but are not limited to, expected time of the store attendant for getting free from the existing customer, location of customer 104, etc.

Time module 206 receives estimated time for assistance from one or more store attendants 110. Selection module 208 selects a store attendant from one or more store attendants 110. The store attendant is selected based on estimated time for assistance received from one or more store attendants 110. Feedback module 210 sends the estimated time for assistance of the selected store attendant to customer 104.

According to an embodiment of the invention, the customer 104 receives the estimated time for assistance of the selected store attendant on the communication device 106.

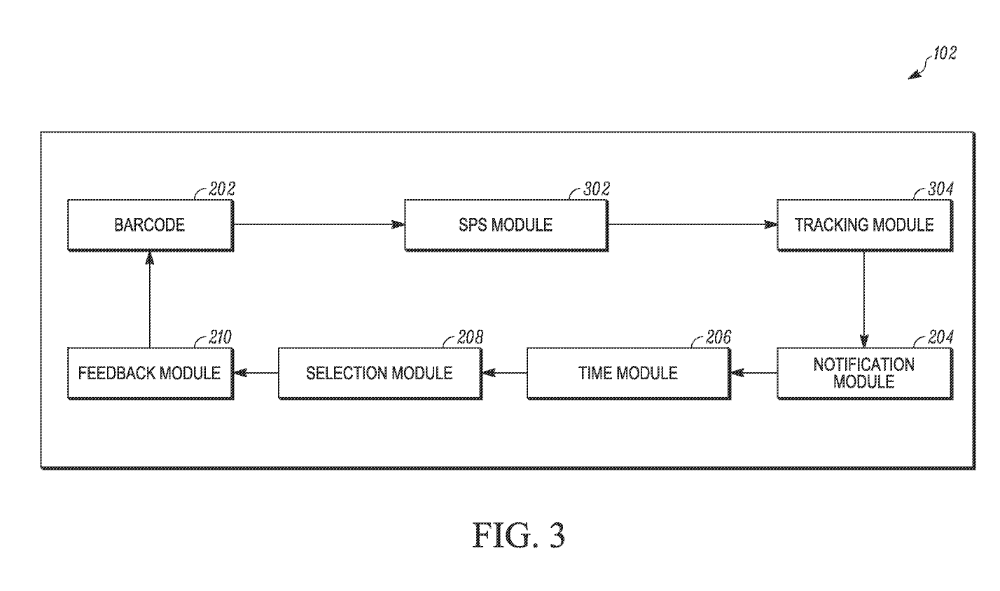

FIG. 3 shows system 102 according to another embodiment of the invention. System 102 for requesting assistance by a customer in a store includes barcode 202, an SPS module 302, a tracking module 304, notification module 204, time module 206, selection module 208 and feedback module 210. Barcode 202 is scanned through communication device 106 by the customer requiring assistance.

According to an embodiment of the invention, barcode 202 is scanned by an application on a mobile phone of customer 104.

Subsequently, SPS module 302 gets the location of one or more store attendants 110. Examples of SPS module 302 include, but are not limited to, one or multiple of GPS, SSID tracking triangulation, computer vision tracking, or any other means of positioning a human or mobile device inside a building. Tracking module 304 selects at least one store attendant based on the location of one or more store attendants 110.

According to an embodiment of the invention, the at least one store attendant is selected based on a pre-defined distance. The pre-defined distance being defined by the store management and at least one store attendant being selected based on the pre-defined distance calculated by SPS module 302.

Notification module 204 sending a notification comprising aisle location to the at least one store attendant. Examples of the notification include, but are not limited to a “Push” notification or a “Poll” for new Notifications. Time module 206 receives estimated time for assistance from the at least one store attendant. Selection module 208 selects a store attendant from the at least one store attendant, the store attendant is then selected based on the estimated time for assistance received from the at least one store attendant. Feedback module 210 sends the estimated time for assistance of the selected store attendant to customer 104.

According to an embodiment of the invention, system 102 further includes a display. Examples of the display, include, but are not limited to, a LCD and a touch screen.

According to another embodiment of the invention, the estimated time for assistance of the selected store attendant is shown on the display to customer 104.

According to yet another embodiment of the invention, system 102 further may include a wireless networking module for communicating with the one or more input devices 112 possessed by one or more store attendants 110 via network 108.

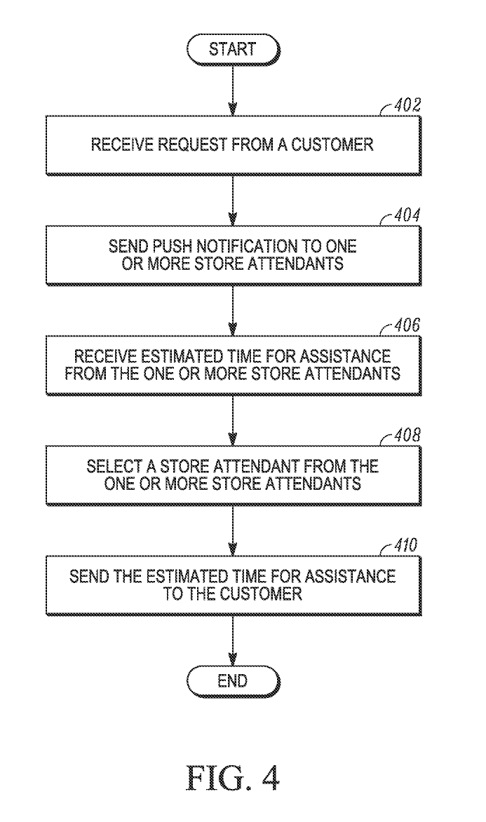

FIG. 4 shows a flowchart for requesting assistance from a store attendant in accordance with an embodiment of the invention. At step 402, a request is received from customer 104. Subsequently, at Step 404, a notification is sent to one or more store attendants 110. The notification may include aisle location corresponding to customer 104.

According to an embodiment of the invention, one or more store attendants 110 provide estimated time corresponding to their respective workload.

Further, estimated time for assistance from the one or more store attendants 110 is received at step 406. Thereafter, at step 408 a store attendant is selected from one or more store attendants 110. Finally, estimated time for assistance for the selected store attendant is sent to customer 104 at step 410.

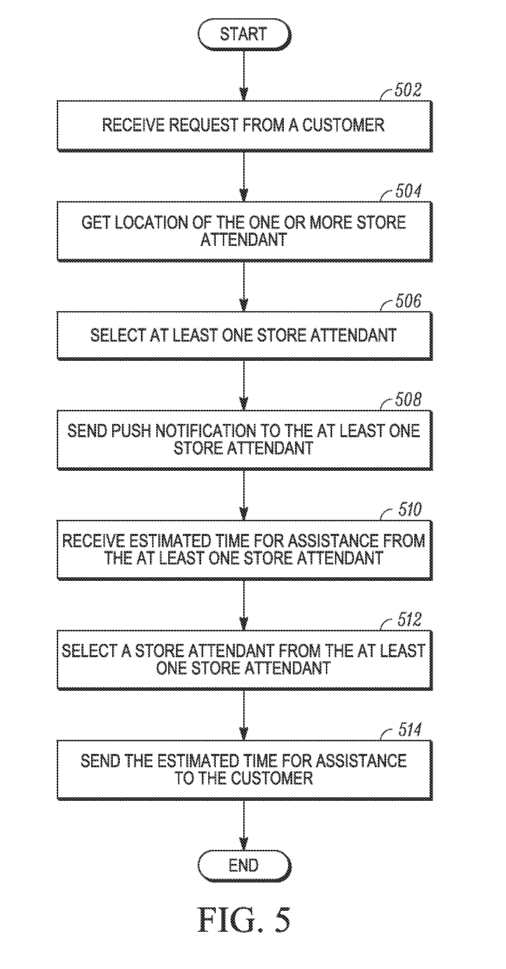

FIG. 5 shows a flowchart for requesting assistance from a store attendant in accordance with another embodiment of the invention. At step 502, a request is received from a customer 104.

According to an embodiment of the invention, request is received via scanning of a barcode located nearby to customer 104 via an application present in the communication device of customer 104.

According to another embodiment of the invention, a request is received via a request device located nearby to customer 104 in the store.

Subsequently, at step 504, location of one or more store attendants 110 is assessed. Thereafter, at least one store attendant is selected based on the location of one or more store attendants at step 506. At Step 508, a notification is sent comprising aisle location to the at least one store attendant. Afterwards, estimated time for assistance from the at least one store attendant is received at step 510. Following step 510, a store attendant is selected from the at least one store attendant based on the estimated time for assistance received from the at least one store attendant at step 512. Finally, the estimated time for assistance of the selected store attendant is sent to customer 104 at step 514.

Different embodiments may provide a number of advantages and solve many of the unmet needs of the customer in the shopping venues. The system and method help the customers in getting assistance from the store attendants. The system and method facilitate the customer in getting the assistance in least possible time resulting from efficient work load distribution among the store attendant. Moreover, the system and method help in efficient employee utilization by gathering employee utilization stats.

While the invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A system for requesting assistance by a customer in a store, the system comprising:
a. a barcode, the barcode being scanned through a communication device by the customer requiring assistance;
b. a notification module, the notification module sending a notification comprising aisle location to one or more store attendants;
c. a time module, the time module receiving estimated time for assistance from the one or more store attendants;
d. a selection module, the selection module selecting a store attendant from the one or more store attendants, the store attendant being selected based on estimated time for assistance received from the one or more store attendants; and
e. a feedback module, the feedback module sending the estimated time for assistance of the selected store attendant to the customer.

2. The system according to claim 1, wherein the barcode is scanned by an application on the communication device of the customer.

3. The system according to claim 1, wherein the communication device is one of a tablet, an iPad®, a PDA or a mobile phone.

4. The system according to claim 1, wherein the aisle location corresponds to the location of the customer.

5. The system according to claim 1 further comprising an SPS module for estimating the location of the one or more store attendants, wherein the SPS module is one or multiple of GPS, SSID tracking triangulation, Computer Vision tracking, or any other means of positioning a human or mobile device inside a building.

6. The system according to claim 5, wherein the notification is one of a “Push” notification or a “Poll” for new Notifications and is sent based on the location of the one or more store attendants.

7. A system for requesting assistance by a customer in a store, the system comprising:
a. a barcode, the barcode being scanned through a communication device by the customer requiring assistance;
b. an SPS module, the SPS module getting location of one or more store attendants;
c. a tracking module, the tracking module selecting at least one store attendant from the one or more store attendants based on the location of the one or more store attendants;
d. a notification module, the notification module sending a notification comprising aisle location to the at least one store attendant;
e. a time module, the time module receiving estimated time for assistance from the at least one store attendant;
f. a selection module, the selection module selecting a store attendant from the at least one store attendant, the store attendant being selected based on the estimated time for assistance received from the at least one store attendant; and
g. a feedback module, the feedback module sending the estimated time for assistance of the selected store attendant to the customer.

8. The system according to claim 7, wherein the barcode is scanned by an application on a communication device of the customer.

9. The system according to claim 7, wherein the communication device is one of a tablet, an iPad®, a PDA or a mobile phone and the SPS module is one or multiple of GPS, SSID tracking triangulation, computer vision tracking, or any other means of positioning a human or mobile device inside a building.

10. The system according to claim 7, wherein the aisle location corresponds to the location of the customer.

11. The system according to claim 7, wherein the notification is one of a “Push” notification or a “Poll” for new notifications.

12. A method for requesting assistance by a customer in a store, the method comprising:
a. receiving request from a customer through a communication device of the customer;
b. sending a notification comprising aisle location to one or more store attendants;
c. receiving estimated time for assistance from the one or more store attendants;
d. selecting a store attendant from the one or more store attendants, the store attendant being selected based on the estimated time for assistance received from the one or more store attendants; and
e. sending the estimated time for assistance of the selected store attendant to the customer.

13. The method according to claim 12, wherein receiving request from the customer via the communication device comprises scanning a barcode located near to the customer.

14. The method according to claim 12, wherein the communication device is one of a tablet, an iPad®, a PDA or a mobile phone.

15. The method according to claim 12 further comprising receiving the estimated time of the selected store attendant on the communication device of the customer.

16. The method according to claim 12, wherein notification is one of a “Push” notification or a “Poll” for new Notifications and is sent based on location of the one or more store attendants.

17. A method for requesting assistance by a customer in a store, the method comprising:
a. receiving request from a customer through a communication device of the customer;
b. getting location of one or more store attendants;
c. selecting at least one store attendant based on the location of the one or more store attendants;
d. sending a notification comprising aisle location to the at least one store attendant;
e. receiving estimated time for assistance from the at least one store attendant;
f. selecting a store attendant from the at least one store attendant, the store attendant being selected based on the estimated time for assistance received from the at least one store attendant; and
g. sending the estimated time for assistance of the selected store attendant to the customer.

18. The method according to claim 17, wherein the communication device is one of a tablet, an iPad®, a PDA or a mobile phone.

19. The method according to claim 17 further comprises receiving the estimated time of the selected store attendant on the communication device of the customer.

20. A computer program product for use with a computer, the computer program product comprising a computer storage medium having a computer readable program code assigned therein for requesting assistance by a customer in a store, the computer program code performing the steps of:
a. receiving request from a customer through a communication device of the customer;
b. sending a notification comprising aisle location to one or more store attendants;
c. receiving estimated time for assistance from the one or more store attendants;
d. selecting a store attendant from the one or more store attendants, the store attendant being selected based on the estimated time for assistance received from the one or more store attendants; and
e. sending the estimated time for assistance of the selected store attendant to the customer.

21. A computer program product for use with a computer, the computer program product comprising a computer storage medium having a computer readable program code assigned therein for requesting assistance by a customer in a store, the computer program code performing the steps of:
a. receiving request from a customer through a communication device of the customer;
b. getting location of one or more store attendants;
c. selecting at least one store attendant based on the location of the one or more store attendants;
d. sending a notification comprising aisle location to the at least one store attendant;
e. receiving estimated time for assistance from the at least one store attendant;
f. selecting a store attendant from the at least one store attendant, the store attendant being selected based on the estimated time for assistance received from the at least one store attendant; and
g. sending the estimated time for assistance of the selected store attendant to the customer.
